(19) United States
(12) Patent Application Publication
(10) Pub. No.: US 2024/0067420 A1
(43) Pub. Date: Feb. 29, 2024

(54) FLEXIBLE SCOOP

(71) Applicant: Alexander Juhasz, Midland, MI (US)

(72) Inventor: Alexander Juhasz, Midland, MI (US)

(21) Appl. No.: 17/821,933

(22) Filed: Aug. 24, 2022

(51) Int. Cl. B65D 51/24; G01F 19/00

(52) U.S. Cl. CPC B65D 51/246; G01F 19/002

(57) ABSTRACT

A scoop for moving dried materials from one space to another manufactured from a flexible base and flexible tabs. A scoop configured from a cover for a container. The scoop is configured such that at least two upright tabs are attached to the inside surface of the cover and are flexible such that when the cover is folded inwardly, the tabs cross and provide a barrier for the dried materials.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

U.S. Pat. No. 7,032,632 entitled, “Measuring and Dispensing Closure”, issued to Shingle on Apr. 25, 2006, teaches a dispensing closure that has an integral measuring device and spoon applicator. The closure has an internal thread on a skirt for fitting onto a container flush. The closure has a tubular measuring device depending from the base wall within the radial confines of the skirt and ending at the spoon applicator for ease of oral administration. This device is not a measuring scoop it is a dispensing tool.

Another example, U.S. Pat. No. 6,578,725 entitled, “Container Lid With Finger-Receiving Scoop”, issued to Delman et. Al., on Jun. 17, 2003, teaches a lid that creates a seal around a container to allow storage and reduce spoil time of the contents. Integrally formed with the lid is a scoop extending into the can so that the contents may be removed without soiling another utensil. The lid is adapted to securely attach to a container opening. The scoop portion has a finger receiving cavity to allow for simplified operator use. The finger receiving scoop extends from the underside of the lid into the container. The scoop is nearly the length of the container and is used to assist the individual to remove the contents of the container. Once finished, the individual may seal the container with the lid until further use is desired, preventing spoiling of the remaining food inside.

Another example, U.S. Pat. No. 5,407,089 entitled, “Storage Container Lid Scoop” issued to Bird et. Al., on Apr. 18, 1995, teaches a storage container assembly that comprises a lid and a base. The lid body has a scoop recess forged in a forward end for collecting articles, and a handlebar extending from the recess to a rearward end wall of the lid. The handlebar has a hand opening beneath and is positioned on the longitudinal center axis of the lid. The lid pivots about horizontal pivot pins to selectively enclose and uncover the top opening of the container and the lid is detachable from the container upper rim by the handlebar, whereby enabling the user to collect refuse into the scoop recess. The stated point of this lid is to collect debris, not to collect the material from the container and dispense it.

Another example, U.S. Pat. No. 11,008,142 entitled, “Lid and Scoop For A Container” issued to Pietraniec et. al., on May 18, 2021, teaches a lid and scoop assembly for a container. This disclosure has a lid with a scoop attached to its underside.

None of the prior art devices provide a flexible scoop for moving dried ingredients from one space to another space.

Further, none of the prior art devices create a measuring device when the lid of the container is folded creating a barrier that allows the user to remove contents of the container in a measured amount. This measuring area can be graduated to allow precise measuring of the contents every time it is used.

### BRIEF SUMMARY OF THE INVENTION

The present invention is a flexible scoop. The scoop comprises a flexible base having an inside surface. There are at least two adjacent, but spaced apart tabs attached to a surface of said flexible base wherein, when the flexible base flexes towards a center of the flexible base, a scoop is formed for moving dried materials from one space to another space.

In another embodiment, there is a scoop cover for containers. The scoop cover comprises a flexible container cover with an inside surface, at least two adjacent, but spaced apart tabs attached to the inside surface of the container cover wherein, when the cover is removed from the container then inverted and flexed towards a cover center wherein a scoop is formed for scooping any contents from the container.

It is contemplated within the scope of this invention to provide more than one set of tabs. For example, there can be two, four or six tabs.

The flexible base and or the tabs can be manufactured from plastic, cardboard, or paper. The flexible base can be manufactured from plastic, cardboard, or paper.

The overall size of the tabs is predetermined to enable a specific quantity of dried materials to be scooped.

It is contemplated within the scope of this invention to also have tabs as an integral part of the cover and wherein the tabs are attached to the cover independently of the manufacture of the cover.

### BRIEF DESCRIPTION OF THE SEVERAL VIEWS OF THE DRAWING(S)

FIG. 1 is a full bottom view of the scoop cover.

FIG. 2 is a full bottom view of the scoop cover wherein the scoop cover is folded.

FIG. 3 is a side view that shows the first and second tabs.

FIG. 4 shows the first and second tabs when the scoop cover is folded.

FIG. 5 is a full bottom view of a scoop cover with more than one tab.

FIG. 6a is a full bottom view of a flexible material showing two tabs.

FIG. 6B is a full bottom view of a flexible material showing four tabs.

### DETAILED DESCRIPTION OF THE INVENTION AND DRAWINGS

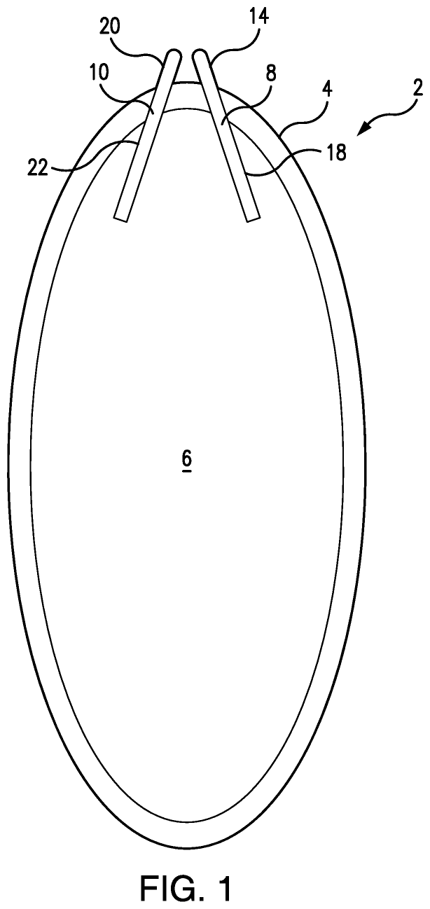

FIG. 1 is a full bottom view of a scoop cover 2 showing the inside surface 6. There is a center 12 (or near center) of scoop cover 2. Near the cover center 12 there is attached to the cover 2, a first tab 8 and a second tab 10. The first tab 8 has a inside edge 16 and an outside edge 18. The second tab 10 has an inside edge 20 and an outside edge 22.

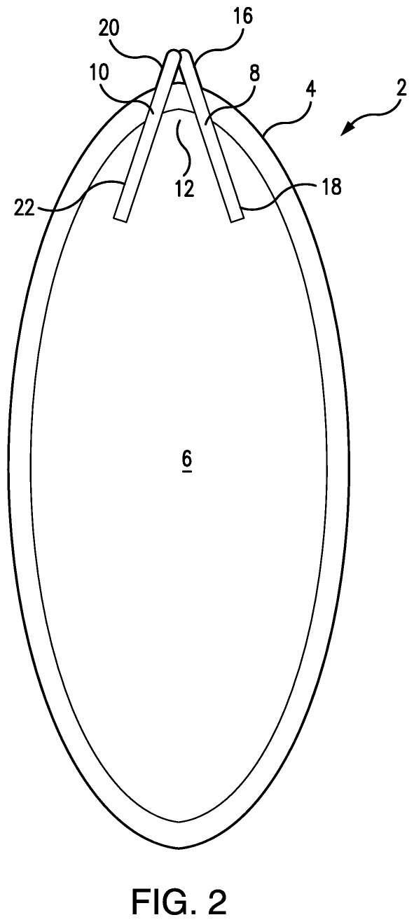

FIG. 2 shows the inside surface 6 of the scoop cover 2 from above while folded. When the scoop cover 2 is folded the first tab 8 and the second tab 10 are forced to overlap near the center 12 of the scoop cover 2. It has been discovered that this overlapping creates a scoop out of the container cover 4. At this point the scoop formed from the folding of the scoop cover 2 can be used to remove graduated amounts or specific quantities of material from a container. The ability to use the scoop cover 2 as a measuring tool eliminates the need to find and use another utensil to complete removal of the contents from the container.

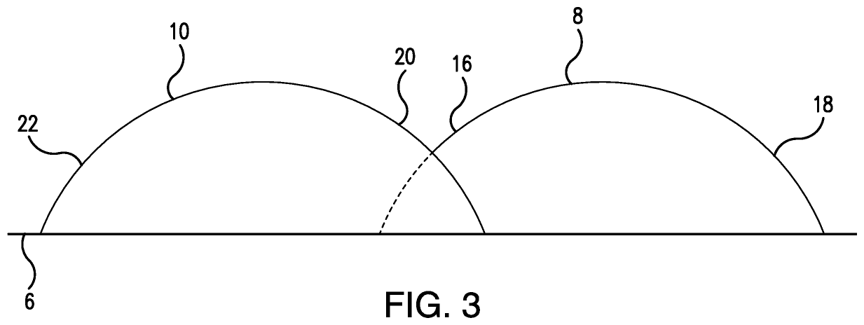

FIG. 3 shows the first tab 8 and second tab 10. The first tab 8 and second tab 10 are attached to the inside surface 6 of the scoop cover 2. The first tab 8 has an inside edge 16 and an outside surface 18. The second tab 10 has an inside surface 20 and an outside surface 22.

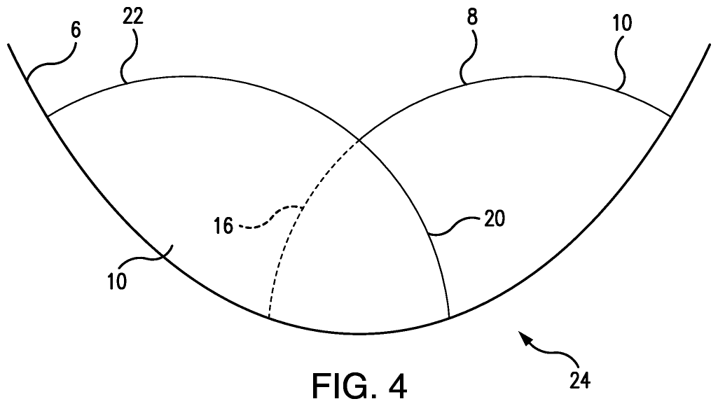

FIG. 4 shows the first tab 8 and second tab 10 when scoop cover 2 is folded. The folding action forces the first tab 8 toward the center 12 of the scoop cover 2. At the same time, the second tab 10 is also forced toward the center 12 where the first tabs 8 inside edge 16 and the second tabs 10 inside edge 20 overlap creating an integral barrier 24. This barrier 24 creates the scoop within the scoop cover 2. This barrier can contain a graduation wherein a predetermined measurement or specific quantity can be removed from the container.

Contemplated within the scope of this invention is a scoop cover 2 wherein the tabs 8 and 10 are an integral part of the cover 4.

Also contemplated within the scope of this invention is a scoop cover wherein the tabs 8 and 10 are attached to the cover 4 independently of the manufacture of the cover 4.

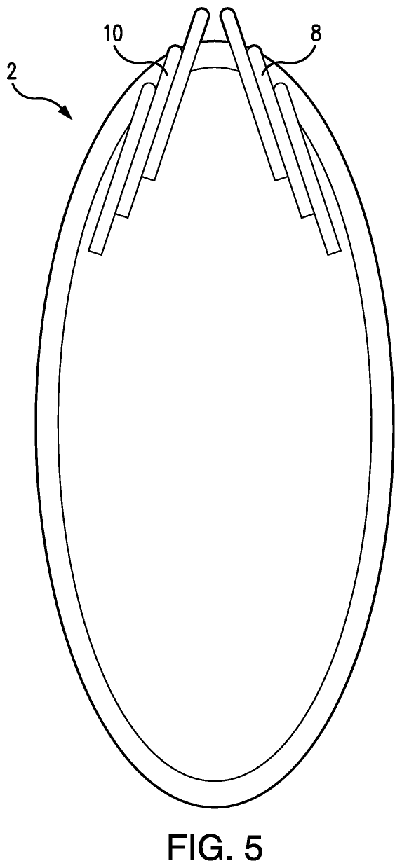

In another embodiment as shown in FIG. 5 is a cover 2 that is partially folded and shows additional tabs 8 and 10. Each of the tabs is attached at their bottoms and allowed to slide against one another to form the scoop.

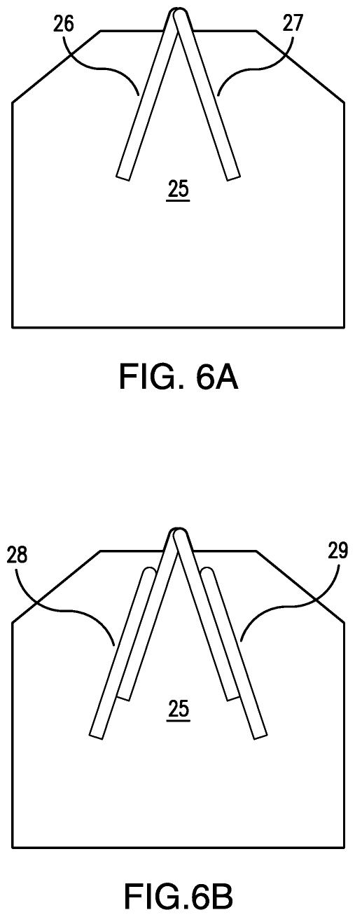

FIGS. 6A and 6B show a flat flexible material 25 that is not a scoop. The flat flexible material 25 has mounted on the surface, tabs 26 and 27 that slide together when the flat flexible material 25 is folded inwardly. This action forms a scoop out of the tabs. FIG. 6B shows an additional set of tabs 28 and 29 on flat flexible material.

What is claimed is:

1. A flexible scoop said scoop comprising:
A. a flexible base having an inside surface;
B. at least two adjacent, but spaced apart tabs attached to said inside surface of said flexible base wherein, when said flexible base is flexed towards a center of said flexible base, a scoop is formed for moving dried materials from one space to another space.

2. A scoop as claimed in claim 1 wherein said scoop is manufactured from plastic.

3. A scoop as claimed in claim 1 wherein said scoop is manufactured from cardboard.

4. A scoop as claimed in claim 1 wherein said scoop is manufactured from paper.

5. A scoop as claimed in claim 1 wherein the overall size of said tabs is predetermined to enable a specific quantity of said contents to be scooped.

6. A scoop as claimed in claim 1 wherein said tabs are manufactured from plastic.

7. A scoop as claimed in claim 1 wherein said tabs are manufactured from cardboard.

8. A scoop as claimed in claim 1 wherein said tabs are manufactured from paper.

9. A scoop as claimed in claim 1 wherein said tabs are an integral part of said scoop.

10. A scoop as claimed in claim 1 wherein said tabs are attached to said scoop independently of the manufacture of said scoop.

11. A scoop cover for containers, said scoop cover comprising a flexible container cover with an inside surface;
at least two adjacent, but spaced apart tabs attached to the inside surface of the container cover wherein, when the cover is removed from the container then inverted and flexed towards a cover center a scoop is formed for conveying dried materials from one space to another space.

12. A scoop cover as claimed in claim 11 wherein said cover is manufactured from plastic.

13. A scoop cover as claimed in claim 11 wherein said cover is manufactured from cardboard.

14. A scoop cover as claimed in claim 11 wherein said cover is manufactured from paper.

15. A scoop cover as claimed in claim 11 wherein the overall size of said tabs is predetermined to enable a specific quantity of said contents to be scooped.

16. A scoop cover as claimed in claim 11 wherein said tabs are manufactured from plastic.

17. A scoop cover as claimed in claim 11 wherein said tabs are manufactured from cardboard.

18. A scoop cover as claimed in claim 11 wherein said tabs are manufactured from paper.

19. A scoop cover as claimed in claim 11 wherein said tabs are an integral part of said cover.

20. A scoop cover as claimed in claim 11 wherein said tabs are attached to said cover independently of the manufacture of said cover.
